(19) United States
(12) Patent Application Publication
(10) Pub. No.: US 2024/0330884 A1
(43) Pub. Date: Oct. 3, 2024

(54) DEBIT MY DATA CUSTOM LOGO AND FACIAL RECOGNITION SYSTEM AND METHOD FOR MONETIZATION OF NON-FUNGIBLE TOKENS

(71) Applicant: Preska Thomas, Port Saint Lucie, FL (US)

(72) Inventor: Preska Thomas, Port Saint Lucie, FL (US)

(21) Appl. No.: 18/129,785

(22) Filed: Mar. 31, 2023

(51) Int. Cl. G06Q 20/12; G06Q 30/0241

(52) U.S. Cl. CPC G06Q 20/1235; G06Q 30/0276; G06Q 30/0277; G06Q 2220/18

(57) ABSTRACT

A system for monetizing value of non-fungible tokens (NFT) is provided comprising a computer and application executing thereon that captures personal logo material of a user, embeds the logo material into an NFT of the user, posts the NFT on a blockchain, invites advertisers to associate corporate logos with the NFT, receives funds from a first advertiser for advertising services using the NFT with a corporate logo of the first advertiser associated therewith, and captures a portion of the funds for remittance to the user. The system provides an application for local use by the user to at least one of capture the personal logo, the personal logo comprising at least one of an image of the user and a logo representing the user. The system embeds the captured personal logo into the NFT. Associations of logos with NFTs by advertisers comprises insertion of corporate logos into the NFTs.

### CROSS REFERENCE TO RELATED APPLICATIONS

None

### FIELD OF THE DISCLOSURE

The present disclosure is in the field of blockchain technology and non-fungible tokens (NFT). More particularly, the present disclosure provides systems and methods of creating NFTs embedded with owners' images and inducing advertisers to associate their logos with the NFTs with the advertisers then distributing the NFTs in advertising content to leverage off the influence and in some cases celebrity of the owners of the NFTs.

### BACKGROUND

The rapid growth of digital assets and non-fungible tokens (NFTs) has transformed the way value, ownership, and digital content are perceived. NFTs have unlocked numerous opportunities for artists, collectors, and businesses, enabling the unique representation and transfer of digital assets on blockchain platforms. However, the current NFT ecosystem is facing challenges related to energy consumption, storage, advertising, user data monetization, and cybersecurity, which hinder its widespread adoption and long-term sustainability.

The advent of blockchain technology has paved the way for new opportunities in various industries, particularly the world of digital assets and NFTs. These unique tokens have emerged as a powerful tool for artists, collectors, and businesses to represent and transfer digital assets securely and transparently. As the NFT market continues to grow, several challenges have emerged that limit its potential and hinder widespread adoption.

Energy Consumption: The current NFT ecosystem, particularly those built on Ethereum, is known for its high energy consumption due to the Proof of Work (PoW) consensus mechanism. This has raised concerns about the environmental impact and long-term sustainability of NFTs.

Storage and Accessibility: Many NFT platforms lack efficient storage solutions and user-friendly interfaces, making it difficult for users to access, view, or interact with the content embedded in their NFTs.

Advertising and Data Monetization: The potential for NFTs to act as a means of advertising and user data monetization remains largely untapped. NFT owners do not have a clear and simple way to benefit financially from their digital assets, and advertisers lack efficient channels for reaching targeted audiences through NFTs.

Cybersecurity: As NFTs gain popularity and value, cybersecurity risks have become increasingly apparent. Secure methods of verifying the authenticity of NFTs and protecting user data are essential for the continued growth and success of the NFT market.

### BRIEF DESCRIPTION OF THE FIGURE

FIG. 1 is a block diagram of a system for monetization of non-fungible tokens according to an embodiment of the present disclosure.

### DETAILED DESCRIPTION

Systems and methods described herein promote monetizaton of non-fungible tokens (NFT) by providing a centralized and blockchain-based system that integrates facial recognition technology with a blockchain-based non-fungible token (NFT) advertising model. The system promotes influencers and other users to place logos on NFTs and videos for sharing on social media and mobile devices.

The system pays users a percentage of the advertising dollars spent by corporate sponsors and advertisers who associate their logos and other indicia with the NFTs. The system, which may be referred to commercially as Debit My Data, may provide a more targeted and personalized advertising experience through the use of NFTs and facial recognition technology.

The system provides a front end comprising an application or app executing on an influencer's or other user's mobile device. The app captures an image of the influencer's face, logo, or other object and embeds the image into a new or existing NFT of the influencer. The system then inserts the NFT into a blockchain and associates the NFT with a smart contract.

Advertisers, for example corporations, may wish to associate their products or services with influencers or similar parties who are popular on social media for various reasons. Influencers, a term used broadly herein, may post messages or other content on social media that comment on products, for example, or on broader social, economic, or political topics or issues.

Systems and methods provide for corporate advertisers to insert their logos or other content into the NFTs of such influencers that have been created using systems and methods provided herein. The advertisers then use the NFTs in their own advertising, such as in banners of internet web pages. The banners containing the advertising also feature the influencer, including the influencer's logo comprising the image of the influencer's face or other content embedded earlier into the influencer's NFT by the system. The corporate advertiser may realize positive value from its association in its advertiser with the influencer because of the influencer's large following on social media or elsewhere.

The system captures a portion of the advertiser's advertising budget and remits it to the influencer. The influencer is hence incentivized to allow advertisers to associate their logos with the influencer's NFT. This may broaden the influencer's overall electronic reach and presence and therefore increase the value of the influencer's NFT(s) and overall message. Assuming the advertiser's advertising content is positively received, the association of the advertiser with the influencer may positively impact the advertiser's sales of featured products or otherwise positively impact the advertiser's messaging and own influence.

Of course, the scenario described above may apply to situations involving advertising for things other than commercial products. Politicians, journalists, activists, and religious organizations and preachers may want their messages associated with influencers to extend their own reach and breadth of influence.

An influencer who is popular on social media may have his or her NFT viewed by thousands or millions of viewers. That popularity may be attractive to corporate advertisers, particularly if the influencer draws views from the type of viewers that an advertiser has identified as its target audience and market. Incentivizing social media users who are popular with the right viewers to use the system provided herein may prove profitable for both the influencer and the corporate advertiser.

As noted, the front-end app may be installed on a mobile device of the influencer. The app captures an image of the influencer's face and embeds the image into the new or existing NFT of the influencer. The system maintains a database of images of the influencer as well as other media of the influencer. The influencer may at his/her discretion change the media contained within his/her NFT and may create additional NFTs. The system endeavors to charge “gas fees” that are reasonable when the influencer seeks to “remint” his/her NFT for reposting back on the blockchain of the system that is hosted on the Ethereum, EOS, Tron, or similar blockchain systems. This activity is documented within smart contracts created by the system and inserted into the blockchain of the system.

The database of the images of the influencer is also used for security purposes to challenge potential impostors who may seek to hijack the influencer's NFT for nefarious purposes. Should an impostor or other person with ill intent seek to hijack an NFT, the system may demand the impostor to show his/her face for capturing of image. The system would then compare with captured image to a stored image in the database of the true owner of the NFT to determine validity of the impostor's alleged identity.

The system may also insert bar codes or radio frequency identification (RFID) tags into the NFTs on behalf of subscribing advertisers such that sales of the advertisers' products may be tracked and web sites displaying the advertising can be identified. The system is directed to assisting advertisers in targeting their advertising effectively to the correct audiences. This means choosing the best NFTs to be associated with. The embedding of bar codes and RFID tags assists in such tracking. When the bar codes or RFID tags are placed onto physical merchandise, the merchandise can be tracked as it moves from factory, farm, or other source along its supply chain to the ultimate consumer.

The facial recognition module and biometric data capturing module for identification techniques that execute on the influencer's mobile device may function on Web2, Web3, Phone, and Android platforms. The modules may integrate with OpenSea, Coinbase and other exchanges.

The system includes a facial recognition library or software development kit (SDK) that is compatible with both Android and iOS mobile platforms. This may include libraries such as OpenCV, Google Vision, or Face++.

The system comprises at least one algorithm that deposits a percentage of advertising budget to influencers or other users who mint, create click corporate logos on an NFT. The algorithm for distributing a percentage of an advertising budget to individuals who click on a corporate logo on an NFT functions as follows:
1. The system creates a smart contract on a blockchain platform that can track clicks on the corporate logo on the NFT.
2. The system establish a percentage of the advertising budget that will be allocated to rewards for clicks on the corporate logo.
3. The smart contract will distribute the rewards proportionally to the number of clicks each user has made on the corporate logo.

The system comprises at least one mathematical equation for tracking the number of logos placed on NFTs:
Let L be the total number of logos placed on NFTs, and N be the total number of NFTs on the internet.
The equation for tracking the number of logos placed on NFTs on the internet is:
L/N=x % where x is the percentage of NFTs that have logos placed on them.

The above equation is used to track the progress of placing logos on NFTs over time by taking multiple samples of the number of logos and NFTs at different times and calculating the percentage of NFTs with logos.

The system further comprises at least one algorithm to identify a specific set of NFTs that can hold logos:
1. Define the criteria for the NFTs that are capable of holding logos. For example, the NFTs must be images or videos, or they must have a certain resolution or file size.
2. Search for NFTs on the blockchain platform where they are stored using the defined criteria. This can be done by querying the blockchain's API or using a tool or library that allows for searching the blockchain.
3. For each NFT that meets the criteria, retrieve the metadata associated with the NFT. The metadata will contain information such as the image or video file associated with the NFT, as well as other information such as the owner's wallet address.
4. Filter out the NFTs that do not meet the criteria for holding logos.
5. Store the remaining NFTs in a list or array that can be used to add logos to these specific NFTs.

The system further comprises at least one algorithm that allows users to turn their TikTok or YouTube videos into NFT by placing logos.
1. Create a user interface that allows users to upload a TikTok or YouTube video, and select a logo to add to the video.
2. Use video editing software to add the selected logo to the video.
3. Convert the edited video into a file format that is compatible with the blockchain platform where the NFTs will be stored.
4. Create a smart contract on the blockchain platform that can handle the creation and management of NFTs.
5. Upload the edited video file to the blockchain and use the smart contract to mint an NFT that represents ownership of the video with the added logo.
6. Associate the metadata of the NFT with the user's wallet address, so that the user becomes the owner of the NFT.
7. Notify the user that the NFT has been created and is ready for them to view and manage.

The system further comprises at least one algorithm or mathematical equation that that allows users to turn their TikTok or YouTube videos into NFTs by placing logos. The process of adding a logo to a video mathematically may involve use of the following equation:
Let V be the original video, L be the logo that is being added, and E be the edited video with the logo added.
The equation for adding a logo to a video can be represented as: E=V+L

The above equation represents the process of combining the original video V with the logo L to create the edited video E with the logo added.

The system further comprises at least one algorithm or mathematical equation that tracks all NFTs on the Internet. The algorithm tracks a specific subset of NFTs on the Internet. The algorithm searches for NFTs on different blockchain platforms using specific criteria, and then uses a mathematical equation to calculate certain statistics about the tracked NFTs.

For example, one could search for NFTs with certain characteristics, such as those associated with a particular artist or those that have a certain market value. A mathematical equation is then used to calculate statistics such as the average price of NFTs in the subset or the total number of NFTs in the subset. The algorithm would be specific to the criteria and the statistics a party wishes to calculate.

The system further comprises at least one mathematical equation that tracks a specific subset of Ethereum NFTs. The algorithm involves searching for NFTs on the Ethereum blockchain using specific criteria, and then using a mathematical equation to calculate certain statistics about the tracked NFTs.

For example, one could search for NFTs using the Ethereum blockchain's API, using specific smart contract addresses or a specific range of block numbers. A mathematical equation would then be used to calculate statistics such as the total number of NFTs minted on the Ethereum blockchain in a specific period of time or the total volume of transactions made for a certain NFT.

The system may also be used as an NFT advertising platform via steps summarized as follows:
1. Develop a website or mobile application that allows advertisers to create and manage their advertising campaigns.
2. Create a smart contract on the blockchain platform that can handle the creation and management of NFTs.
3. Allow advertisers to upload their ad content, such as images or videos, and associate them with a smart contract.
4. Allow advertisers to set their ad campaign's parameters, such as targeting, budget, and duration.
5. Mint an NFT for each ad campaign and associate the ad content with the NFT.
6. Allow advertisers to bid on the NFTs, using the native cryptocurrency of the blockchain platform.
7. Allow advertisers to view the statistics of their ad campaigns, such as the number of impressions and clicks.
8. Allow advertisers to withdraw their ad campaign's budget at the end of the campaign.
9. Allow advertisers to view the statistics of the ad campaigns, such as the number of impressions and clicks.

The system includes an advertising algorithm. As noted, the system includes a facial recognition module and biometric data capturing module for identification techniques on Web2, Web3, Phone, and Android platforms to determine the relevance and effectiveness of an NFT logo embedded advertisement The algorithm takes into account several factors, such as keyword relevance, ad relevance, landing page experience, and ad performance, in order to determine the ad's quality score on the blockchain. The algorithm processes a large amount of data, both historical and real-time, to make predictions about the embedded logo NFT ad's relevance and effectiveness, and to determine the ad's quality score.

The mobile app allows influencers and other users to put logos on YouTube videos and Twitter, turn them into NFTs, and then distribute them as advertising banners on Google, YouTube, Twitter and social media, summarized as follows:
1. The user interface of the mobile app use a mobile app development framework such as React Native and Flutter.
2. A party would implement the video editing tools that allow users to add logos to their videos and make other edits.
3. The mobile app is integrated with the blockchain platform where the NFTs will be stored to mint NFTs for each video with a logo.
4. The mobile app is integrated with social media platforms, such as Google, YouTube, Twitter, and other platforms, to allow users to distribute the videos as advertising banners for launch at the App Store and Google Play store.

The system provides an algorithm that sends NFTs with logos to social media, with steps summarized as follows:
1. A user interface is created that allows users to upload a video and select a logo to add to the video.
2. Video editing software is used to add the selected logo to the video.
3. The edited video is converted into a file format that is compatible with the blockchain platform where the NFTs will be stored.
4. A smart contract is created on the blockchain platform that can handle the creation and management of NFTs.
5. The edited video file is uploaded to the blockchain. The smart contract is used to mint an NFT that represents ownership of the video with the added logo.
6. The NFT is shared on social media platforms, such as Twitter, Instagram, and Facebook, by providing a link to the NFT on the blockchain.
7. Users are allowed to view the NFT on the social media platforms and are allowed to purchase or bid on the NFT if they are interested in owning it.

The system provides an algorithm that tracks specific subsets of NFTs on the web. The algorithm involves searching for NFTs on different blockchain platforms and web pages using specific criteria, and then using a mathematical equation to calculate certain statistics about the tracked NFTs.

For example, one would search for NFTs with certain characteristics, such as those associated with a particular artist or those that have a certain market value. A mathematical equation is then used to calculate statistics such as the average price of NFTs in the subset or the total number of NFTs in the subset. The algorithm is specific to the criteria and the statistics a party may want calculated of the data obtained from the web and blockchain platforms. The algorithm includes the implementation of web scraping techniques, data processing, and data storage.

The system allows for NFT advertising on centralized websites, summarized as follows:
1. The user interface of the application was designed and developed using web development frameworks comprising React, Angular or Vue.js.
2. NFT creation and management tools were implemented that allow users to mint NFTs and associate them with their advertising content.
3. The application was integrated with the blockchain platform where the NFTs will be stored, in order to mint NFTs for each advertising content.
4. The application was integrated with centralized websites, such as Google, YouTube, Twitter, and other platforms, to allow users to display the NFTs as advertising banners.
5. The application was tested for bugs and errors and make any necessary adjustments.
6. The application was deployed on a web server, making it accessible to users.

The system may be integrated with centralized websites or Google, YouTube, Twitter, and other platforms, to allow users to display the embedded logo NFTs as advertising banners, summarized as follows:
1. The system manages APIs provided by centralized websites such as Google, YouTube, Twitter, and other platforms for integration. The system includes a repository and database of APIs and corporate logos available for advertising.
2. The API repository and logo database system is a registry account register as a developer on the centralized websites' developer platforms.
3. The API and Logo repository system automates to capture the necessary API keys and credentials for the APIs that will be used, such as the Ads API for Google or the Twitter Ads API.
4. The system uses the APIs to create the necessary advertising campaigns and banner ads on the centralized websites for the distribution of NFT embedded logos.
5. The APIs are used to associate the NFTs with the advertising campaigns and banner ads, by providing the smart contract address and other information.
6. The integration is tested to ensure that the NFTs are correctly displayed as advertising banners on the centralized websites.
7. The performance of the advertising campaigns is continuously monitored and adjustments are made as necessary.

An API key to integration to ensure that the NFTs are correctly displayed as advertising banners on the centralized website is as follows:
makefileCopy code
api_key=“1234567890abcdefghijklmnopqrstuvwxyz”

The API key is used to authenticate the application's access to the centralized website's API. The actual format and structure of the API key would depend on the specific API being used and the requirements of the centralized website.

The API key can be passed in the headers of HTTP requests to the API, along with other information such as the smart contract address and other parameters.

makefileCopy code
headers = { “Authorization”: “Bearer ” + api_key, “Content-Type”:
“application/json”
}

In the embed logo system, the headers of the request include the API key, and other parameters such as the smart contract address and the NFT information. Additionally, the system and API keys are secure and not share it with unauthorized parties.

A blockchain header banner for centralized websites is now discussed. Advertisers and AI use a combination of techniques to understand what specific products or services a user is looking for in order to send relevant advertisements. Some of the main methods include:
1. Keyword analysis: Advertisers analyze the keywords that users are searching for on search engines and social media platforms in order to understand their interests and intent. AI can be used to analyze large amounts of data and identify patterns in keyword usage, which can help advertisers understand what specific products or services a user is looking for.
2. Behavioral targeting: Advertisers track a user's online behavior, such as the websites they visit and the items they purchase, in order to understand their interests and preferences. AI can be used to analyze this data and identify patterns in a user's behavior, which can help advertisers understand what specific products or services a user is looking for.
3. Contextual targeting: Advertisers analyze the content of a webpage, such as the text, images, and videos, in order to understand the context of the page and the products or services that are being discussed. AI can be used to analyze this data and identify patterns in the content, which can help advertisers understand what specific products or services a user is looking for.
4. Demographic targeting: Advertisers use demographic data, such as age, gender, income, and location, to understand the characteristics of their target audience and the products or services they are likely to be interested in. AI can be used to analyze this data and identify patterns in the demographic data, which can help advertisers understand what specific products or services a user is looking for.
5. Predictive modeling: Advertisers use machine learning algorithms to analyze data from multiple sources to predict a user's behavior and interests. Predictive modeling can help advertisers to anticipate what specific products or services a user is looking for. The system utilizes predictive modeling advertiser code using machine learning algorithms to analyze data from multiple sources in order to predict a user's behavior and interests. This predictive modeling advertiser code can help advertisers to anticipate what specific products or services a user is seeking.

The system includes Python script that uses a machine learning algorithm to predict a user's behavior and interests based on data from multiple sources as follows:
pythonCopy code
import pandas as pd from sklearn.ensemble import RandomForestRegressor from sklearn.model_selection import train_test_split from sklearn.metrics import mean_absolute_error #Load the data from multiple sources data=pd.read_csv(‘user_data.csv’) #Select the features to use for prediction features=[‘age’, ‘gender’, ‘income’, ‘location’, ‘website_visits’, ‘purchases’] #Define the target variable target=‘interests’ #Split the data into training and test sets X_train, X_test, y_train, y_test=train_test_split(data[features], data[target], test_size=0.2) #Initialize the model model=RandomForestRegressor( ) #Train the model on the training data model.fit(X_train, y_train) #Use the model to make predictions on the test data y_pred=model.predict(X_test) #Calculate the mean absolute error of the predictions mae=mean_absolute_error(y_test, y_pred) #Print the mean absolute error print(f‘Mean Absolute Error: {mae}’)

The above script uses the Random Forest algorithm from the scikit-learn library to predict a user's interests based on data from multiple sources such as age, gender, income, location, website visits, and purchases. The script loads the data from a CSV file, selects the features to use for prediction, defines the target variable and then splits the data into training and test sets. After that the script trains the model on the training data and uses it to make predictions on the test data. The script then calculates the mean absolute error of the predictions, which is a measure of how accurate the predictions are.

As noted, facial recognition is integrated with an Android and iPhone mobile app and an NFT advertising system. The system pays users a percentage of advertising dollars spent by corporate brands that target them for their data. This involves several steps as follows:
1. Develop a mobile app that uses the chosen facial recognition library or SDK to capture images of users' faces and extract facial features. The app should also be able to interact with the blockchain network where the NFTs will be stored.
2. Implement the NFT creation and management feature in the mobile app. This will involve setting up smart contracts that will manage the creation and storage of NFTs on the blockchain network.
3. Implement a data tracking feature, which will allow users to track the data that is collected about them and how it is being used.
4. Implement the payment feature, which will allow users to receive a percentage of the advertising dollars spent by corporate brands that target them for their data.
5. Test the system to ensure that it is working correctly and that it meets the requirements defined in step 2 above.

Creating and managing content on Logo NFTs is designed to be a seamless and cost-effective process, making it accessible to a wide range of users. Users can mint new NFTs by paying a small gas fee. This fee is significantly lower than those associated with traditional cryptocurrencies, making the process more affordable and accessible. To mint a new NFT, users can either upload their custom logo, use facial recognition to create a personalized NFT with their face, or choose from a range of pre-designed logos.

Once an NFT is created, users can load additional content onto the NFT by paying an incremental gas fee. This additional fee is also kept low to encourage users to store and share various types of content on the blockchain. Users can upload content such as images, videos, audio, and text files, allowing for a diverse range of digital assets to be stored and shared using logo NFTs.

Logo NFTs can be managed and shared using the provided platform. Users can view their NFTs, add or update content, and share their NFTs with others using the platform's intuitive user interface. This streamlined process ensures that even non-technical users can interact with the system and take advantage of the benefits offered by the platform's NFT system. By offering an affordable and user-friendly process for creating, managing, and sharing logo NFTs, the platform encourages the mass adoption of digital assets and wealth generation in the cryptocurrency space.

As noted, if a user attempts to modify or access an NFT that features a facial recognition logo that does not match their own face, the platform's facial recognition technology will identify the discrepancy and flag the attempt as suspicious. The imposter may instantly see a signal providing warning messages.

In the event of an attempted unauthorized access, the platform will capture the image of the imposter's face and securely store it for further investigation and user awareness.

The system offers a subscription service for users who wish to receive updates and notifications regarding potential imposter attempts on their NFTs. Subscribers will have access to a dedicated section of a website where they can view captured images of imposters who have tried to access their facial recognition logo NFTs. This feature allows users to stay informed about the security of their digital assets and take necessary actions to protect their NFTs.

By implementing these security measures and providing an imposter alert subscription service, the system aims to ensure the safety and privacy of users and their digital assets on the platform. This level of protection may foster trust in the system and may encourages the mass adoption of digital assets and wealth generation in the cryptocurrency space.

The system allows for users to store and preserve valuable digital assets, such as important documents, images, and smart contracts. By paying additional gas fees, users can upload and store vital information on their existing minted NFTs, which are embedded with a logo or facial recognition data. This feature serves as a secure and accessible digital storage solution for various purposes, including estate preservation.

NFTs can be used to securely store essential documents, such as property deeds, wills, and legal contracts, ensuring their preservation and safekeeping. The platform's security measures, including facial recognition and imposter detection, protect these documents from unauthorized access and potential tampering.

By storing smart contracts on NFTs under the system, users can automate and manage various aspects of their estate, such as property transfers, inheritance distribution, and asset management. This feature simplifies estate planning and administration, making it more efficient and accessible.

NFTs can also be used to store and preserve personal and family assets, such as photographs, videos, and other digital media. By keeping these valuable memories on the blockchain provided by the system, users ensure their long-term preservation and easy accessibility for future generations. The platform offers a cost-effective and accessible digital storage solution by allowing users to pay incremental gas fees for uploading additional content to their existing NFTs.

This feature makes secure digital storage more affordable and accessible to a wider range of users. By offering secure and affordable digital storage solutions, NFTs provide a versatile platform for storing and preserving valuable digital assets, including important documents, smart contracts, and personal memories. This approach to digital storage and preservation may encourage the mass adoption of digital assets and wealth generation in the cryptocurrency space.

The platform offers a cost-effective and accessible digital storage solution by allowing users to pay incremental gas fees for uploading additional content to their existing NFTs. This feature makes secure digital storage more affordable and accessible to a wider range of users. By offering secure and affordable digital storage solutions, NFTs provide a versatile platform for storing and preserving valuable digital assets, including important documents, smart contracts, and personal memories.

The system allows users to create and mint logo NFTs, which can be loaded with various content types, including videos, images, and text. This feature provides a way for users to store and share digital assets on the blockchain.

Corporate sponsors and advertisers can choose from existing logo NFTs and add their logos alongside the end user's logo. Sponsors or advertisers can then distribute the co-branded NFT as part of their advertising campaigns.

When a sponsor or advertiser pays to distribute an embedded logo NFT, the owner of the NFT receives 5% or other percentage of the advertising budget deposited to their electronic wallet, PayPal account, or debit card. The blockchain is designed to be scalable, secure, and efficient, providing the foundation for the ecosystem.

Smart contracts on the blockchain enable seamless interactions between users, advertisers, and the network, automating processes and reducing the need for intermediaries. Wallets and user interfaces provided by the system are designed to be intuitive and easy to use, ensuring that even non-technical users can easily interact.

In addition to the logo NFTs, the platform offers the option for end-users to either use a custom logo or their own face as the logo for the NFT. This feature adds a personal touch to the NFTs, allowing users to further customize their digital assets.

Users can leverage their NFTs to create and promote their personal brand across various platforms, using their face or custom logo as the central identity. Influencers can utilize NFTs to collaborate with brands and advertisers, creating co-branded NFTs that leverage the influencer's face or custom logo to engage and monetize their audience. NFTs can be integrated into gaming and entertainment platforms, allowing users to create and share personalized digital assets based on their face or custom logos.

Artists and collectors can use NFTs to create and trade digital art pieces featuring their face or custom logo, adding a unique and personal touch to their digital art collections. As NFTs are used to store and preserve important personal and family assets, advertisers and sponsors have the opportunity to engage with a targeted audience that is likely to value their association with a secure and trusted platform. This targeted audience engagement can lead to higher conversion rates and a stronger return on investment for advertising and sponsorship campaigns.

By promoting their brands through embedded logo NFTs, advertisers and sponsors can showcase their innovative approach to marketing, setting themselves apart from competitors. This advertising medium can help create a memorable and lasting impression on potential customers, increasing brand awareness and customer loyalty. NFT owners can benefit from the monetization of their stored assets through advertising and sponsorship deals. As advertisers and sponsors pay to promote embedded logo NFTs, NFT owners receive a percentage of the advertising budget, providing them with an additional revenue stream.

The association with reputable advertisers and sponsors can enhance the perceived value of NFTs, potentially increasing their market value. This increased value benefits NFT owners by providing them with a more valuable and sought-after digital asset.

By having their NFTs promoted by advertisers and sponsors, NFT owners can benefit from increased visibility and exposure for their stored assets. This enhanced visibility can lead to greater recognition and appreciation of the stored assets, potentially increasing their cultural and historical significance. By providing a valuable proposition for advertisers, sponsors, and NFT owners, NFTs create a unique ecosystem that encourages the mass adoption of digital assets and wealth generation in the cryptocurrency space. The synergy between asset preservation and promotion may allow parties to benefit from the innovative features and secure storage capabilities of embedded logo NFTs.

Advertising agencies and media buy agencies log on to the blockchain to either sponsor most viral social media videos (YouTube, Amazon video, TikTok) already transformed into templates for embedding corporate logos and promotion/giveaway details. They may also elect to advertise directly by uploading client print ads, Internet campaigns, television commercials, and movie trailers for also embedding individual corporate logo onto selected templates. Other steps include the selection of distribution reach, payment and submission to mobile carrier networks or Internet of All Things hard-copy limited edition collectible similar to bitcoins or hard-copy collectible debit cards.

Digital NFTs distributed over mobile networks and the Internet are tagged to include individual barcodes. At the administrative panel, advertiser or sponsor may elect to pay additional dollars to create collectible limited edition hard-copy versions of their most viral daily NFTs. NFTs, once manufactured as limited edition collectible hard-copy, includes the unique barcode already established as distributed to the mobile networks and will also include RFID tag for enabling links between Internet of All Things and for being embedded into the mobile subscriber lifestyle as a trusted corporate logo.

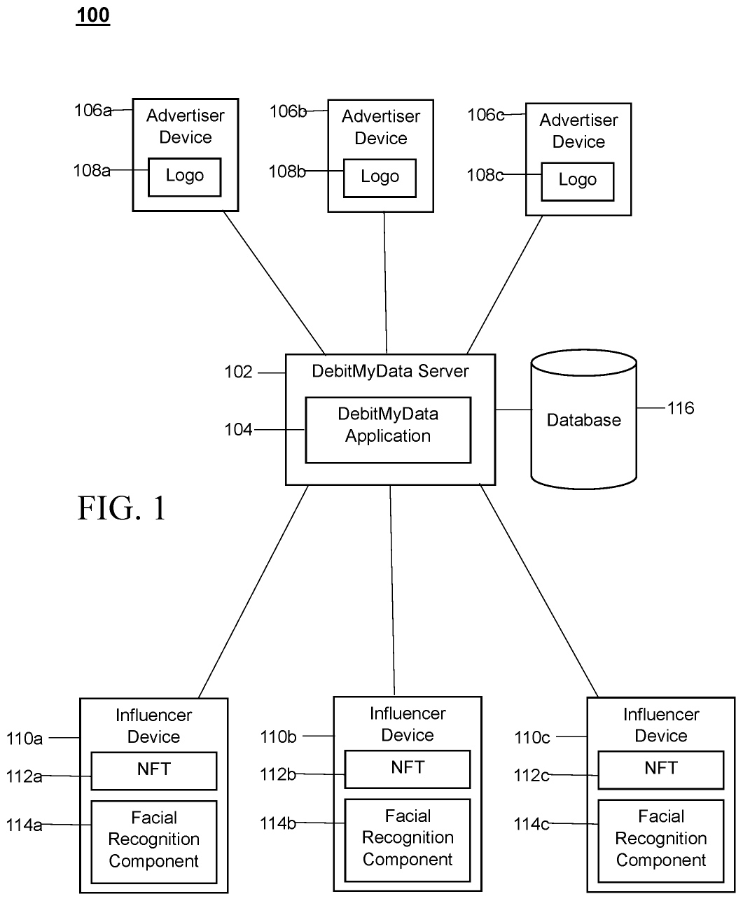

FIG. 1 depicts components and interactions of a system 100 a Debit My Data system. The system 100 comprises a DebitMyData Server 102 and a DebitMyData application 104, hereafter referred to respectively for brevity purposes as the server 102 and the application 104. The system 100 also comprises advertiser devices 106a-c and logos 108a-c. The advertiser devices 106a-c are used by advertisers that wish to place their logos 108a-c into NFTs 112a-c of influencers or users. The system 100 also comprises influencer devices 110a-c, NFTs 112a-c, and facial recognition components 114a-c that capture images of influencers' faces for embedding of the images into the NFTs 112a-c and for security purposes. The system 100 also comprises a database 116 which contains types of media described above.

In an embodiment, a system for monetizing value of non-fungible tokens is provided comprising a computer and application executing thereon that captures personal logo material of a user, embeds the logo material into a non-fungible token (NFT) of the user, posts the NFT on a blockchain, invites advertisers to associate corporate logos with the NFT, receives funds from a first advertiser for advertising services using the NFT with a corporate logo of the first advertiser associated therewith, and captures a portion of the funds for remittance to the user.

The system provides an application for local installation and use by the user to at least one of capture the personal logo, the personal logo comprising at least one of an image of the user and a logo representing the user. The system embeds the captured personal logo into the NFT.

The association of corporate logos with the NFT by advertisers comprises insertion of the corporate logos by the advertisers into the NFT. The advertisers advertise products in banner advertisements in Internet web pages displaying material from the NFT featuring the user and further advertising the association of the advertiser with the user.

Advertisers additionally embed radio frequency identification (RFID) tags and barcode information into the NFT. The system deploys an application programming interface (API) that interacts with the RFID tags and barcode information to read and store information about products of an advertiser advertised with the NFT, the information about the products comprising at least one of names, descriptions, and prices of the products. Advertisers adjust at least one of size, position, and orientation of their corporate logos to fit within the NFT.

In another embodiment, method for assisting firms to partner with influencers in online advertising. The method comprises a computer receiving a message from an advertiser, the message requesting advertising partnering services with influencers associated with a first theme. The method also comprises the computer searching a database for non-fungible tokens (NFT) owned by parties associated with the first theme. The method also comprises the computer locating and presenting to the advertiser at least one NFT owned by a party associated with the first theme. The method also comprises the computer, based on a selection by the advertiser, associating a corporate logo of the advertiser with the at least one NFT found while searching. The method also comprises the computer remitting a portion of an advertising budget of the advertiser to the at least one party owning the NFT.

The method also comprises the computer operating the database to store NFTs of influencers associated with themes popular with consumers of social media. The method also comprises the computer analyzing content of stored NFTs to identify themes of the content at least partially aligning with the first theme.

The method also comprises the computer incentivizing owners of NFTs to add content to the NFTs to enhance attractiveness of the NFTs to advertisers. The method also comprises the computer facilitating reminting the NFTs after content is added to the NFTs. The method also comprises the computer notifying NFT owners that association with reputable advertisers and sponsors potentially enhances the perceived value of the NFTs, potentially increasing market value of the NFTs.

In yet another embodiment, a system for associating corporate logos with non-fungible tokens of interest is provided comprising a processor, a memory, and an application stored in the memory that when executed on the processor receives a listing of NFTs to which a logo is to be associated. The system also retrieves metadata for each of the listed NFTs, adds the logo to a file associated with each NFT, and updates the metadata for each NFT to include the file containing the added logo.

The logo is associated with an entity seeking association with a party associated with the NFTs. The listing of NFTs is generated by searching for NFTs with certain characteristics, the certain characteristics comprising at least one of association with at least one of an artist and an influencer and having a certain market value.

The metadata contains data comprising at least one of an image of an NFT owner, a video file, and a wallet address of the owner. The entity is an commercial firm seeking to use the association in advertising of its products and services at least in electronic material viewable on Internet web pages. The system periodically adds logos to new NFTs as the new NFTs are created.

What is claimed is:

1. A system for monetizing value of non-fungible tokens, comprising:
a computer and application executing thereon that:
captures personal logo material of a user,
embeds the logo material into a non-fungible token (NFT) of the user,
posts the NFT on a blockchain,
invites advertisers to associate corporate logos with the NFT,
receives funds from a first advertiser for advertising services using the NFT with a corporate logo of the first advertiser associated therewith, and
captures a portion of the funds for remittance to the user.

2. The system of claim 1, wherein the system provides an application for local installation and use by the user to at least one of capture the personal logo, the personal logo comprising at least one of an image of the user and a logo representing the user.

3. The system of claim 2, wherein the system embeds the captured personal logo into the NFT.

4. The system of claim 1, wherein the association of corporate logos with the NFT by advertisers comprises insertion of the corporate logos by the advertisers into the NFT.

5. The system of claim 1, wherein the advertisers advertise products in banner advertisements in Internet web pages displaying material from the NFT featuring the user and further advertising the association of the advertiser with the user.

6. The system of claim 1, wherein advertisers additionally embed radio frequency identification (RFID) tags and barcode information into the NFT.

7. The system of claim 6, wherein the system deploys an application programming interface (API) that interacts with the RFID tags and barcode information to read and store information about products of an advertiser advertised with the NFT, the information about the products comprising at least one of names, descriptions, and prices of the products.

8. The system of claim 1, wherein advertisers adjust at least one of size, position, and orientation of their corporate logos to fit within the NFT.

9. A method for assisting firms to partner with influencers in online advertising, comprising:
a computer receiving a message from an advertiser, the message requesting advertising partnering services with influencers associated with a first theme;
the computer searching a database for non-fungible tokens (NFT) owned by parties associated with the first theme;
the computer locating and presenting to the advertiser at least one NFT owned by a party associated with the first theme;
the computer, based on a selection by the advertiser, associating a corporate logo of the advertiser with the at least one NFT found while searching; and
the computer remitting a portion of an advertising budget of the advertiser to the at least one party owning the NFT.

10. The method of claim 9, further comprising the computer operating the database to store NFTs of influencers associated with themes popular with consumers of social media.

11. The method of claim 9, further comprising the computer analyzing content of stored NFTs to identify themes of the content at least partially aligning with the first theme.

12. The method of claim 9, further comprising the computer incentivizing owners of NFTs to add content to the NFTs to enhance attractiveness of the NFTs to advertisers.

13. The method of claim 12, further comprising the computer facilitating reminting the NFTs after content is added to the NFTs.

14. The method of claim 12, further comprising the computer notifying NFT owners that association with reputable advertisers and sponsors potentially enhances the perceived value of the NFTs, potentially increasing market value of the NFTs.

15. A system for associating corporate logos with non-fungible tokens of interest, comprising:
a processor;
a memory; and
an application stored in the memory that when executed on the processor:
receives a listing of NFTs to which a logo is to be associated,
retrieves metadata for each of the listed NFTs,
adds the logo to a file associated with each NFT, and
updates the metadata for each NFT to include the file containing the added logo.

16. The system of claim 15, wherein the logo is associated with an entity seeking association with a party associated with the NFTs

17. The system of claim 15, wherein the listing of NFTs is generated by searching for NFTs with certain characteristics, the certain characteristics comprising at least one of association with at least one of an artist and an influencer and having a certain market value.

18. The system of claim 15, wherein the metadata contains data comprising at least one of an image of an NFT owner, a video file, and a wallet address of the owner.

19. The system of claim 16, wherein the entity is an commercial firm seeking to use the association in advertising of its products and services at least in electronic material viewable on Internet web pages.

20. The system of claim 15, wherein the system periodically adds logos to new NFTs as the new NFTs are created.
